(19) United States
(12) Patent Application Publication
(10) Pub. No.: US 2012/0319334 A1
(43) Pub. Date: Dec. 20, 2012

(54) INTERNAL GAS PRESSURE METHOD FOR PRODUCING PLASTIC PARTS

(76) Inventors: Andreas Praller, Germering (DE); Mikael Orsén, Trelleborg (SE); Marcel Op de Laak, Freiburg (DE)

(21) Appl. No.: 13/328,295

(22) Filed: Dec. 16, 2011

(30) Foreign Application Priority Data
Jan. 11, 2011 (DE) 102011008260.3
Apr. 12, 2011 (EP) 11003092.1

(51) Int. Cl. B29D 22/00

(52) U.S. Cl. 264/572

(57) ABSTRACT

A method for producing a molded part, wherein a molten polymer is introduced into a mold space of a molding tool and liquid carbon dioxide with a pressure of at least 160 bar, preferably with a pressure of at least 200 bar or at least 250 bar is supplied to the mold space, whereby the polymer is pressed against the walls of the mold space and a space is formed in the polymer.

### CROSS REFERENCE TO RELATED APPLICATIONS

This application claims priority from German Patent Application DE 102011008260.3 filed Jan. 11, 2011 and European Patent Application EP 11003092.1, filed Apr. 12, 2011.

### BACKGROUND OF THE INVENTION

The invention relates to a method for producing a molded part, wherein a molten polymer is introduced into a mold space of a molding tool and a pressure fluid is supplied to the mold space, whereby the polymer is pressed against the walls of the mold space.

The so-called internal gas pressure method is often used to produce molded parts comprising hollow areas or channels. In the case of this method, a pressure fluid, typically nitrogen, is injected into a cavity of an injection molding tool, which is not completely filled with melt, at a high pressure, for example between 50 bar and 300 bar. The nitrogen presses the melt out of the center of the cavity against the walls of the cavity, whereby the desired space is created.

In the case of the so-called secondary cavity method, a main cavity is initially filled completely with the melt and a part of the melt is subsequently pressed into a secondary cavity, which is connected to the main cavity, by means of a pressure fluid, for example by means of nitrogen, so that the desired hollow space forms in the main cavity.

In addition, the mass push-back method or push-back method is also known, in the case of which, analogous to the secondary cavity method, the cavity is initially filled with a melt, which is supplied via a conveying screw. The pressure fluid then moves a part of the melt not into a secondary cavity, but back into the conveying screw.

Among others, the advantages of the internal gas pressure technology are that less material is used for the production of the molded part, that a higher accuracy can be attained, that shrink marks can be removed, that molded parts can be produced, which encompass a higher stability and stiffness, that the cycle times can be reduced, that stresses in the material of the molded part, which are caused by the molding, can be reduced greatly, and that injection molding machines comprising a lower clamping force can be used.

A method for the internal gas pressure technology comprising an interior cooling is known from EP 1 259 368 B1. In the case of this method, nitrogen is guided through the space in the plastic material while the polymer cools down and hardens in the cavity, so as accelerate the cool-down and hardening.

In response to a temperature of 100° C. and a pressure of 200 bar, the density of nitrogen is 166 kg/cm³, in response to lower pressures, the density is considerably lower. It has thus been proposed already to use water instead of nitrogen for cooling the plastic material. In response to the mentioned conditions of 100° C. and 200 bar, the density of water is 967 kg/m³. In addition to the higher density, water also has a larger heat capacity than nitrogen. The cooling effect, which can be reached in response to the use of water as cooling medium, is accordingly greater and the cycle times, which can be attained with water, are accordingly shorter.

However, the use of water has numerous disadvantages: The produced molded plastic part must be dried carefully after the hardening. In addition, specific plastic types must be used, which are hydrolysis-resistant. Leakages at the water-bearing parts also often lead to serious quality problems.

It is thus the object of the instant invention to specify an improved internal gas pressure method comprising an interior cooling. In particular, a quick cool-down of the plastic melt in the cavity is to be attained.

### SUMMARY OF THE INVENTION

This object is solved by means of a method for producing a molded part, wherein a molten polymer is introduced into a mold space of a molding tool and a pressure fluid is supplied to the mold space, whereby the polymer is pressed against the walls of the mold space, and which is characterized in that liquid carbon dioxide with a pressure of at least 150 bar, preferably with a pressure of at least 200 bar or at least 250 bar is used as pressure fluid.

In the context of this application, the term “molding tool” is used for an injection molding tool, which encompasses a mold space, which is suitable for producing a plastic or metal molded part, for example for producing large quantities of plastic parts. For this purpose, liquid plastic or a liquid polymer are injected into the tool at a high pressure, the molded part cools down and is ejected from the tool after a certain time.

As a rule, the molding tool consists of two or more tool parts, which can be moved separately from one another or relative to one another, so as to open and close the tool.

The invention relates to the so-called internal gas pressure method. According to the invention, the molding tool is closed, whereby a mold space is formed in the interior of the molding tool. The molten polymer is introduced or injected, respectively, into the mold space of the molding tool. To cool down the melt, liquid carbon dioxide is used according to the invention at a high pressure of at least 150 bar. A space is to thereby be created in the melt by means of the pressure of the supplied carbon dioxide.

The critical point of carbon dioxide lies at a temperature of approximately 31.0° C. and a pressure of 73.8 bar. The polymer located in the mold space has a temperature of more than 50° C., mostly even considerably more than 100° C., so that overcritical conditions are mostly at hand for the carbon dioxide after the supply into the mold space. According to the invention, carbon dioxide is supplied, which is available in the liquid aggregate state prior to entering into the molding tool. After the injection into the mold space, the carbon dioxide will typically transfer into the overcritical state due to the described temperature ratios.

It turned out that, under these conditions, the carbon dioxide has very good heat transfer characteristics on the one hand and that it is also very well suited as pressure fluid on the other hand. Due to the carbon dioxide, the molten polymer is pressed against the inner walls of the molding tool quickly and effectively, so as to form the desired molded part. In addition, the heat transfer from the polymer to the carbon dioxide is high, so that the molded part, which is to be produced, cools down quickly and the inner surfaces of the molded part encompass a high surface quality. In addition to the good heat conductivity, the overcritical carbon dioxide also has a high heat capacity, so that an effective cool-down of the polymer is attained. The invention thus allows for a considerable reduction of the time, which is required for producing a molded part. The cycle time, that is, the time from introducing the polymer into the mold space until the removal of the finished molded part from the molding tool, is reduced considerably as compared to methods, in the case of which nitrogen is used as pressure fluid and cooling medium.

The method according to the invention can be used advantageously in particular when molded parts are to be produced, the inner surfaces of which must satisfy high quality demands. The invention is thus preferably used for the manufacture of tubes, in particular tubes or lines comprising a small inner cross section, for example cooling ducts in the automobile industry.

### DETAILED DESCRIPTION OF THE INVENTION

Surprisingly, in the case of the method according to the invention, it turned out that the polymer does not expand at the surface and that a surface quality results, which is otherwise only attained in response to a cooling with water. In contrast to a cooling with water, the invention, however, has the large advantage that the molded part must not be dried after the production and that the method according to the invention is suitable for all plastics and polymers, which are typically used in response to injection molding. On the contrary, only specific plastics can be cooled with the help of a water cooling, because the molded part surface would otherwise be attacked by the water.

The liquid carbon dioxide is preferably introduced into the mold space at a pressure of at least 150 bar, at least 200 bar or at least 250 bar. The density and heat capacity also increase with an increasing pressure, so that an even more effective cool-down is attained. Advantageously, the carbon dioxide is introduced into the mold space at a pressure of maximally 300 bar or 350 bar, because apparatus-related difficulties and density problems can occur in response to higher pressures.

Preferably, liquid carbon dioxide is used as pressure fluid, whereby the characteristic “liquid” relates to the aggregate state prior to the introduction of the carbon dioxide into the mold space. Prior to the supply of the carbon dioxide into the mold space, which is filled with the hot polymer, the carbon dioxide preferably has a temperature of between 15° C. and 30° C., preferably between 15° C. and 25° C. The carbon dioxide heats only after the contact with the polymer and transfers from the liquid into the overcritical state.

The quality of the produced molded part depends on the maximum pressure, which is applied to the melt via the pressure fluid, as well as on the pressure profile, that is, the course of the pressure change to the maximum pressure. Depending on the geometry of the mold space, depending on the arrangement, position and embodiment of the injectors for the melt and the pressure fluid and depending on the used polymer, it may be advantageous not to immediately supply the pressure fluid, that is, carbon dioxide, to the mold space at a pressure of at least 150 bar.

It turned out that the flow speed and the mass flow of the pressure fluid have an impact on the molding of the space in the molded part, which is to be produced. In the case of a mass flow, which is too large, or in the case of a flow speed, which is too high, swirls can occur in the molten polymer, which prevent the embodiment of a space having a high surface quality.

In a preferred embodiment, a molding fluid is thus supplied to the mold space prior to the supply of the pressure fluid, so as to form a space in the polymer, wherein carbon dioxide with a density of less than 500 kg/m³, preferably less than 300 kg/m³, is used as molding fluid.

After the introduction of the molten polymer, that is of the melt, into the mold space, a molding fluid is supplied initially before the liquid carbon dioxide is injected at a high pressure of at least 150 bar. In response to room temperature and a pressure of 150 bar, liquid carbon dioxide has a density of approximately 900 kg/m³. On the contrary, carbon dioxide with a density of less than 500 kg/m³, preferably less than 300 kg/m³, is used as molding fluid. In response to the initial molding process, a molding fluid is thus used, which encompasses a density, which is reduced by half or more as compared to the pressure fluid, namely carbon dioxide at 150 bar. Accordingly, the mass flow of the molding fluid is also considerably lower than that of the pressure fluid. By reducing the mass flow, swirls of the molten polymer are avoided as much as possible in the mold space. In the event that the molding fluid has formed a space in the molt, the supply of the pressure fluid according to the invention can take place.

Advantageously, gaseous carbon dioxide is supplied as molding fluid at a pressure of less than 100 bar, preferably less than 80 bar, preferably less than 60 bar.

In another preferred embodiment, the density decrease as compared to the pressure fluid is attained via a temperature increase. In this case, carbon dioxide at a pressure of more than 150 bar and a temperature of more than 50° C., preferably between 50° C. and 150° C., is used as molding fluid.

In the case of the two above-mentioned alternatives, the use of carbon dioxide in response to low pressure and/or the use of carbon dioxide in response to higher temperature, the molding fluid has a considerably reduced density as compared to carbon dioxide at room temperature and a pressure of 150 bar, whereby the mass flow is reduced and the described swirls are avoided for the most part.

In addition, it turned out that the quality of the molded part can be influenced via the size and the course of the pressure increase. The pressure of the molding fluid is thus advantageously increased during the supply of the molding fluid such that the pressure change is less than 50 bar/s, preferably less than 30 bar/s. For example, the pressure in the mold space or in the melt, respectively, is consistently increased to 60 bar, 70 bar or 80 bar within 2 to 3 seconds by supplying the molding fluid.

The invention is particularly suitable for the production of a molded part according to the secondary cavity method or according to the push-back method. In the case of the secondary cavity method, a secondary cavity is connected to the mold space, in which the molding tool is to be molded and produced. The melt is introduced into the mold space and is partially displaced subsequently into the secondary cavity by means of the molding fluid and/or by means of the pressure fluid. The melt, which remains in the mold space, is pushed against the wall of the mold space and is cooled down.

The push-back method or also the mass push-back method differs from the secondary cavity method in that a part of the melt is not displaced into a secondary cavity, but back into the feed line or screw conveyor, via which the melt was previously guided into the mold space.

In the case of the push-back method, the melt must be displaced from the mold space against a considerably higher pressure than in the case of the secondary cavity method. The above-described approach with a molding fluid and a pressure fluid proved to be particularly advantageous, in particular in the case of the push-back method.

In a preferred embodiment, the carbon dioxide, which is used as pressure fluid, and/or the molding fluid are cooled down prior to the injection into the mold space, in particular to a temperature of less than 15° C., preferably less than 10° C., more preferably less than 5° C. Due to the temperature decrease, the liquid carbon dioxide is undercooled and remains in the liquid aggregate state for a longer period of time after the introduction into the mold space before it transfers into the overcritical state under the influence of the hot polymer. In this way, the high heat capacity of the liquid carbon dioxide can be used for a longer period of time and the polymer cools down more quickly.

The pressure fluid and/or the molding fluid are preferably introduced into the mold space via an injector. Due to the described good heat transfer characteristics of carbon dioxide, the injector is cooled by the carbon dioxide, which flows through. When the injector is too hot, in particular when the injector encompasses a temperature above the glass temperature Tg of the polymer or plastic, the danger is that polymer or plastic, respectively, adhere or stick. Such an adhesion is avoided by means of the cooling of the injector with carbon dioxide and it is ensured that the molded part can be removed from the mold after the cool-down without any problems.

A further advantage is that, in response to the use of carbon dioxide, the injector is cleaned to an increased extent by means of the carbon dioxide, which flows through the injector, due to the fact that higher shear forces occur than in the case of nitrogen because of the molecule size of the carbon dioxide in response to the flow-through of the very thin cross sections in the injector in the case of an annular gap injector, annular gaps comprising a width of only 1/100 to 3/100 mm are used, for example.

The invention is particularly suitable for producing molded parts, in the case of which the quality of the inner surfaces is important and should be high, for example for cooling lines, in particular cooling lines for motor vehicles. In addition, the invention shows advantages in response to the production of molded parts comprising a large wall thicknesses, because the cooling times can be reduced considerably by using carbon dioxide at a high pressure. The method according to the invention is typical in response to the production of molded parts, which allow for the use of high gas pressures above 150 bar, particularly preferably above 200 bar or 250 bar.

The invention represents an alternative to the current internal gas pressure technology, in the case of which liquid carbon dioxide is used instead of one or in addition to a gaseous pressure fluid. In the case of the common internal gas pressure methods, the gas, which is used as pressure fluid, is introduced into the mold space via gas injectors. For the most part, these gas injectors are designed as annular gap injectors. A needle is hereby movably arranged in a guide, so that a small annular gap comprising a gap width of 0.01 mm, for example, forms between the needle and the guide.

It turned out that common gas injectors of the above-mentioned type do not represent the optimum in response to the supply of liquid carbon dioxide according to the invention, because liquid carbon dioxide encompasses different flow ratios than gaseous nitrogen. The danger is thus that the mass flow of carbon dioxide into the mold space is too low in response to a dimensioning of the outlet opening, which is too small, and that the mold part is molded more slowly and poorly through this. On the other hand, flow speeds of the carbon dioxide, which are too high, can cause undesired swirls of the polymer in the mold space.

Injectors, the outlet opening of which for the carbon dioxide encompasses a cross sectional surface of more than 0.1 mm², more than 0.5 mm², more than 2 mm² or more than 5 mm², are thus used advantageously. These can thereby be accordingly modified annular gap injectors or other injectors. These injectors can be used for the injection of the pressure fluid, that is, of the liquid carbon dioxide at a high pressure, as well as for injecting the molding fluid. The injectors allow for a high mass flow in response to flow speeds, which are not too high. In response to the use of such injectors, the pressure in the mold space can be built up in a defined manner to 200 bar or 250 bar, for example. The polymer is pressed against the walls of the molding tool quickly and effectively, whereby swirls of the polymer are avoided, so that the molding as well as the cooling of the molded part are improved.

When using annular gap injectors, it turned out to be advantageous to provide at least 5 mm, at least 10 mm or at least 15 mm for the inner diameter of the annular gap. In the case of the above-described embodiment of the annular gap injector comprising a needle, this means that the needle has an outer diameter of at least 5 mm, at least 10 mm or at least 15 mm.

It is also advantageous to use injectors, the outlet opening of which can be opened actively, can be closed or the size of which can be changed. For example, provision can be made for a hydraulic adjusting device, by means of which the cross sectional surface of the outlet opening can be changed.

In particular the supply of the liquid carbon dioxide into the mold space is optimized by means of the mentioned dimensioning of the injector, so that the cycle time or the time, which is required for the production of a molded part, respectively, can be lowered and/or the quality of the molded part can be increased.

In the case of pressure reduction, after the molded part has been molded in the molding tool and has been cooled down, it must be noted that the inner surface of the molded part, which has been removed from the mold, is not damaged by an excessive pressure reduction.

Preferably, the pressure in the mold space is thus reduced at a speed of less than 20 bar/second, in particular at a speed of between 10 bar/second and 20 bar/second. In this manner, a expansion of the inner surface of the molded part is avoided and a high quality of the inner surface is ensured. The claimed range for the pressure reduction speed between 10 bar/s and 20 bar/s represents a good compromise between a pressure decrease, which is as quick as possible, for shortening the cycle time and a pressure decrease, which is as slow as possible, for improving the quality of the inner surface.

Advantageously, the pressure decrease takes place linearly, that is, the pressure is lowered by the same amount per time unit.

Oftentimes, it is advantageous to hold the pressure for a certain time after the maximum pressure has been reached in the mold space, before the pressure decrease is started. For example, a pressure of 250 bar is built up in the mold space by the injection of liquid carbon dioxide, this pressure is held for several seconds, for example between 5 and 20 seconds, and the pressure is then reduced again consistently at a speed of 15 bar/s.

However, it is also possible to start the pressure decrease directly after reaching the maximum pressure in the mold space, so as to minimize the cycle time.

Comparative Test:

A coolant line made of plastic was initially produced according to the common internal gas pressure method, namely in particular according to the push-back method with gaseous nitrogen as pressure fluid. The melt was thereby injected into the molding tool at a temperature of 310° C. The evaluation of the tests resulted in a cooling time of 110 seconds per molded part and a total time for a cycle, that is, the time from the injection of the melt into the molding tool to the injection of the melt for the following molded part, of 123 seconds.

### Example 1

The same component was produced as in the comparative test. Instead of gaseous nitrogen, liquid carbon dioxide was used according to the invention as pressure fluid. The pressure of the supplied liquid carbon dioxide was quickly increased to 250 bar and was then held at this value. The remaining test conditions were maintained. With the use of liquid carbon dioxide as pressure fluid, it was possible to reduce the cooling time from 110 seconds to 60 seconds.

### Example 2

In the next test, the impact of the pressure profile was examined. Contrary to example 1, the pressure was not quickly increased to the maximum pressure, but was built up more slowly and in a defined manner. Initially, gaseous carbon dioxide was introduced into the mold space as molding fluid, so as to push at least a part of the melt back into the screw conveyor. The pressure of the gaseous carbon dioxide was increased to 60 bar within 2 seconds and was subsequently held at 60 bar for 14 seconds. After this holding phase, liquid carbon dioxide was supplied at room temperature and the pressure was increased to 250 bar within 5 seconds. After a holding phase of 5 seconds at 250 bar, the pressure was slowly decreased back to zero. The time for the pressure decrease was 10 seconds. Compared to example 1, it was possible to reduce the cooling time to 36 seconds. The inner surface of the produced coolant lines was of high quality.

### Example 3

In this test, the same molding tool was used again, but a different plastic material was used. Gaseous carbon dioxide was used as molding fluid. The pressure of the gaseous carbon dioxide was increased to 80 bar within 2 seconds and was subsequently held at 80 bar for 13 seconds. After this holding phase, liquid carbon dioxide was supplied at room temperature and the pressure was increased to 250 bar within 5 seconds. After a holding phase of 8 seconds, the pressure was slowly decreased back to zero again. The time for the pressure decrease was 5 seconds. With this plastic, it was possible to reduce the cooling once again to a value of 33 seconds. The inner surface of the produced coolant lines was again of high quality.

The above examples show that a considerable shortening of the cooling and cycle time can be attained by means of the use of liquid carbon dioxide as pressure fluid according to the invention. In addition, a slow pressure increase with the use of a molding fluid brings further advantages in view of the cycle time as well as in view of the quality of the created molded parts.

In particular, it turned out to be advantageous to provide for the following method steps:

a) Supplying a forming fluid until a first pressure appears,

b) Holding the first pressure for a certain time,

c) Supplying liquid carbon dioxide as pressure fluid until a second pressure appears,

d) Holding the second pressure for a certain time,

e) Decreasing the pressure

In the case of the individual method steps, the following parameters turned out to be advantageous:

With reference to a) Preferably, the first pressure is maximally 100 bar, more preferably maximally 80 bar, most preferably maximally 60 bar. The pressure increase is carried out at a speed of less than 50 bar per second, preferably less than 30 bar per second.

With reference to b) The first pressure is preferably maintained for 5 to 30 seconds, preferably 10 to 20 seconds. It is also possible to omit the holding phase.

With reference to c) The second pressure is at least 150 bar, more preferably at least 200 bar, most preferably at least 250 bar. The pressure increase is carried out at a speed of more than 20 bar per second, preferably more than 30 bar per second, preferably more than 50 bar per second.

With reference to d) The second pressure is preferably maintained for 5 to 30 seconds, preferably 10 to 20 seconds. However, this holding phase can also be omitted, if necessary.

With reference to e) The pressure decrease preferably takes place at a speed of between 10 bar/s and 20 bar/s.

What we claim is:

1. A method for producing a molded part, wherein a molten polymer is introduced into a mold space of a molding tool and a pressure fluid is supplied to the mold space, whereby the polymer is pressed against the walls of the mold space, characterized in that liquid carbon dioxide with a pressure of at least 150 bar is used as pressure fluid.

2. The method according to claim 1, characterized in that said pressure is selected from the group consisting at least 200 bar and at least 250 bar.

3. The method according to claim 1, characterized in that carbon dioxide is injected into the mold space or onto a part of the surfaces of the molding tool prior to the introduction of the polymer into the mold space.

4. The method according to claim 1, characterized in that a molding fluid is supplied to the mold space prior to the supply of the pressure fluid, so as to form a space in the polymer, wherein carbon dioxide with a density of less than 500 kg/m³ is used as molding fluid.

5. The method according to claim 4, characterized in that said carbon dioxide has a density of less than 300 kg/m³.

6. The method according to claim 5, characterized in that carbon dioxide is supplied as molding fluid at a pressure of more than 150 bar and a temperature of more than 50° C.

7. The method according to claim 6, characterized in that said temperature is between 50° C. and 150° C.

8. The method according to claim 4, characterized in that gaseous carbon dioxide is supplied as molding fluid at a pressure of less than 100 bar.

9. The method according to claim 8, characterized in that said pressure is selected from the group consisting of less than 80 bar and less than 60 bar.

10. The method according to claim 4, characterized in that the pressure of the molding fluid is increased during the supply of the molding fluid, wherein the pressure change is less than 50 bar/s.

11. The method according to claim 10, characterized in that said pressure change is less than 30 bar/s.

12. The method according to claim 1, characterized in that the pressure fluid and/or the molding fluid are supplied to the mold space via an injector, wherein the outlet opening of the injector encompasses a cross sectional surface of more than 0.1 mm².

13. The method according to claim 12, characterized in that said cross sectional surface is selected from the group consisting of more than 0.5 mm², more than 2 mm² and more than 5 mm².

14. The method according to claim 1, characterized in that the pressure fluid and/or the molding fluid are supplied to the mold space via an annular gap injector.

15. The method according to claim 14, characterized in that the annular gap injector encompasses an annular gap comprising an inner diameter of at least 5 mm.

16. The method according to claim 15, characterized in that said inner diameter is selected from the group consisting of at least 10 mm and at least 15 mm.

17. The method according to claim 1, characterized in that the pressure fluid and/or the molding fluid are cooled down prior to the supply into the mold space to a temperature of less than 15° C.

18. The method according to claim 17, characterized in that said temperature is selected from the group consisting of less than 10° C. and less than 5° C.

19. The method according to claim 1, characterized in that the pressure in the mold space is decreased at a speed of between 10 bar/s and 20 bar/s after the supply of the pressure fluid.

20. The method according to claim 1, characterized in that the pressure in the mold space is increased by supplying the pressure fluid up to a maximum pressure and is held at the maximum pressure between 5 and 20 seconds.

21. The method according to claim 1, characterized in that the molded part is produced according to the secondary cavity method or the push-back method.
